(19) United States
(12) Patent Application Publication
(10) Pub. No.: US 2026/0246886 A1
(43) Pub. Date: Aug. 20, 2026

(54) INFORMATION PROCESSING SYSTEM AND NON-TRANSITORY COMPUTER-READABLE STORAGE MEDIUM

(71) Applicant: FUJIFIM Business Innovation Corp., Tokyo (JP)

(72) Inventor: Yusuke TAGUCHI, Kanagawa (JP)

(73) Assignee: FUJIFIM Business Innovation Corp., Tokyo (JP)

(21) Appl. No.: 19/302,643

(22) Filed: Aug. 18, 2025

(30) Foreign Application Priority Data
Feb. 14, 2025 (JP) 2025-022583

(51) Int. Cl. H04N 1/44

(52) U.S. Cl. CPC H04N 1/4433; H04N 1/4426

(57) ABSTRACT

An information processing system includes a storage device that stores therein usage location information and a candidate of a security-related setting in association with each other, the usage location information including a country or a region, the candidate complying with a law and regulation corresponding to the usage location information; and a processor configured to: acquire the usage location information indicating a usage location where a target device is used; provide the acquired usage location information to the storage device and acquire the candidate of the setting, the candidate corresponding to the usage location information; and present the acquired candidate of the setting to a user of the target device.

### CROSS-REFERENCE TO RELATED APPLICATIONS

This application is based on and claims priority under 35 USC 119 from Japanese Patent Application No. 2025-022583 filed Feb. 14, 2025.

### BACKGROUND

### Technical Field

The present disclosure relates to an information processing system and a non-transitory computer-readable storage medium.

### Related Art

Today, various laws and regulations are in force to protect data. For example, in the United Kingdom, there is the Product Security and Telecommunication Infrastructure (PSTI) Act for information devices connectable to the Internet. In addition, the European Union (EU) has the General Data Protection Regulation (GDPR) to protect personal data.

Examples of the related art include Japanese Unexamined Patent Application Publication No. 2020-154462.

### SUMMARY

A user or an administrator (hereinafter referred to as a "user") of an information device is required to set security-related settings in accordance with the laws and regulations of a usage location. However, when there is no mechanism for checking the settings which have been set, the user cannot notice an error in setting which occurs due to a misunderstanding or an erroneous input.

Assume the case in which new laws and regulations are enforced, the case in which existing laws and regulations are amended, and the case in which an information device is moved to another country or region. In these cases, the security-related settings need to be reviewed. However, in these cases, the user needs to determine, on a case-by-case basis, which items need to be changed and what new settings comply with the laws and regulations.

Aspects of non-limiting embodiments of the present disclosure relate to a technique of facilitating settings that comply with the security-related laws and regulations of a usage location, unlike the case where there is no mechanism for supporting a user's security-related setting.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system comprising: a storage device that stores therein usage location information and a candidate of a security-related setting in association with each other, the usage location information including a country or a region, the candidate complying with a law and regulation corresponding to the usage location information; and a processor configured to: acquire the usage location information indicating a usage location where a target device is used; provide the acquired usage location information to the storage device and acquire the candidate of the setting, the candidate corresponding to the usage location information; and present the acquired candidate of the setting to a user of the target device.

### BRIEF DESCRIPTION OF THE DRAWINGS

Exemplary embodiments of the present disclosure will be described in detail based on the following figures, wherein:

FIG. 1 is a diagram illustrating an exemplary security management system;

FIG. 2 is a diagram illustrating an exemplary hardware configuration of a security setting support server;

FIG. 3 is a diagram illustrating an example of data of recommended setting information.

FIG. 4 is a diagram illustrating an example of parameters related to security;

FIG. 5 is a diagram illustrating an exemplary hardware configuration of an image forming apparatus;

FIG. 6 is a diagram illustrating an exemplary processing sequence related to security setting of an image forming apparatus;

FIG. 7 is a diagram illustrating an exemplary operation screen used to set a usage location and an installation environment;

FIG. 8 is a diagram illustrating an exemplary display screen of recommended security;

FIG. 9 is a flowchart of an exemplary processing operation performed in relation to setting of a usage location;

FIG. 10 is a diagram illustrating a change of a usage location due to a move;

FIG. 11 is a flowchart of an exemplary operation of confirming a usage location;

FIG. 12 is a flowchart of another exemplary operation of confirming a usage location;

FIG. 13 is a flowchart of an exemplary processing operation in which security is to be reviewed in accordance with, for example, a change, after installation, of the business environment of a user;

FIG. 14 is a diagram illustrating an exemplary security management system;

FIG. 15 is a diagram illustrating an exemplary hardware configuration of a security setting support server;

FIG. 16 is a diagram illustrating an example of data of recommended setting information;

FIG. 17 is a diagram illustrating an exemplary hardware configuration of a security policy server;

FIG. 18 is a diagram illustrating an example of data of policy-based security information;

FIG. 19 is a diagram illustrating an exemplary processing sequence related to security setting of an image forming apparatus;

FIG. 20 is a diagram illustrating an exemplary processing sequence related to security setting of an image forming apparatus; and

FIG. 21 is a diagram illustrating an exemplary processing sequence related to security setting of an image forming apparatus.

### DETAILED DESCRIPTION

Hereinafter, exemplary embodiments of the present disclosure will be described with reference to the drawings.

### Terms

Usage location includes a country or a region. Examples of usage location include Japan, the United States of America, and the European Union (EP).

Laws and regulations refer to laws, rules, and standards applied in usage locations. Examples of laws and regulations include the EU General Data Protection Regulation, the Radio Equipment Directive, the Product Security and Telecommunications Infrastructure (PSTI), and Common Criteria (CC) certification.

User includes a business operator (including an individual; the same shall apply hereinafter) who owns a network device, a business operator that uses network devices under lease contracts or rental contracts, an employee (including an administrator or a worker in charge of maintenance and management) of a business operator, and a business operator who undertakes maintenance and management of network devices.

Usage environment refers to an environment in which a network device is used. The usage herein includes usage of a network device which has been installed at a specific location or position, as well as usage of a network device whose location or position is changed over time. That is, usage environment includes information about a usage location.

Furthermore, usage environment includes information about a user who sets a network device and about the scale of the user. The scale is classified into, for example, large corporation, small and medium-sized corporation, and small office home office (SOHO). The usage environment is an example of installation environment information.

Network device refers to electronic devices connected to a local area network (LAN) or the Internet. Examples of network device include image forming apparatuses, computers, automobiles, trains, aircraft, ships, drones, electronic toys, white goods, and medical devices. Examples of computer include a desktop computer as well as a smartphone, a notebook computer, and a tablet computer. Network device is also referred to as an Internet of Things (IoT) device. The network device is an example of a target device.

### First Exemplary Embodiment

### System Configuration

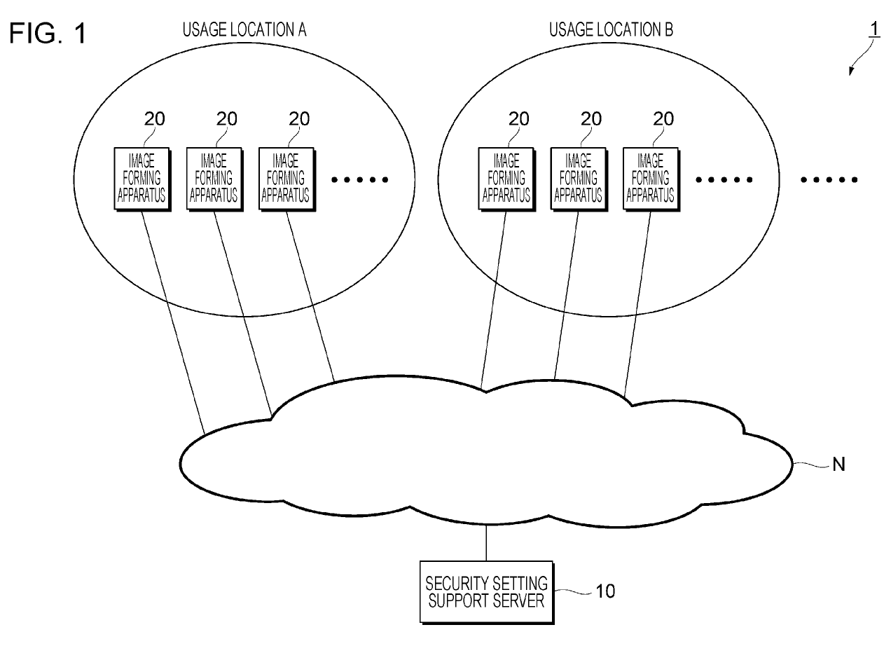

FIG. 1 is a diagram illustrating an exemplary security management system 1. The security management system 1 includes a security setting support server 10 and multiple image forming apparatuses 20, which are connected to a network N.

The security management system 1 is an example of an information processing system. However, each of the security setting support server 10 and the image forming apparatuses 20 may be regarded as an information processing system.

The network N is assumed to be, for example, a LAN or the Internet.

The security setting support server 10 is a server that supports security-related setting of the image forming apparatuses 20. In the case of FIG. 1, one security setting support server 10 is provided. However, the security setting support server 10 may be composed of multiple servers that cooperate with each other.

The image forming apparatuses 20 have a function of forming an image on a sheet or the like (hereinafter referred to as "printing function"). The image forming apparatuses 20 according to the present exemplary embodiment receive support for security setting from the security setting support server 10. In this sense, the image forming apparatuses 20 are examples of a target device.

The image forming apparatuses 20 according to the present exemplary embodiment also have functions other than the printing function. For example, the image forming apparatuses 20 also have a scanner function, a copy function, and a facsimile function.

The scanner function is a function of optically reading a document. The copy function refers to a function of generating a copy of a document. The facsimile function refers to a function of transmitting and receiving a still image by using a public telephone network or the like.

The image forming apparatuses 20 having functions other than the printing function are also referred to as multifunction peripherals. However, the image forming apparatuses 20 may be apparatuses specialized in a printing function (so-called printing apparatuses).

In the case of FIG. 1, the image forming apparatuses 20 include image forming apparatuses 20 used in Usage location A and image forming apparatuses 20 used in Usage location B. As described above, usage location includes a country and a region. For convenience of description, FIG. 1 illustrates only two usage locations A and B. However, the number of usage locations is not limited to two.

The users of the image forming apparatuses 20 may be individuals or corporations. For example, the users may be persons who use the image forming apparatuses 20, or may be individuals or corporations that rent out the image forming apparatuses 20 as objects of lease contracts or rental contracts. For example, the users may be individuals or corporations that undertake maintenance and management of the image forming apparatuses 20.

A single user may use multiple image forming apparatuses 20. In this case, not all of the image forming apparatuses 20 used by a single user need to be used in the same usage location. That is, multiple image forming apparatuses 20 may be used in multiple usage locations. For example, one user may use two image forming apparatuses 20 in Usage location A and three image forming apparatuses 20 in Usage location B.

### The Configuration of Terminals

### Hardware Configuration of Security Setting Support Server 10

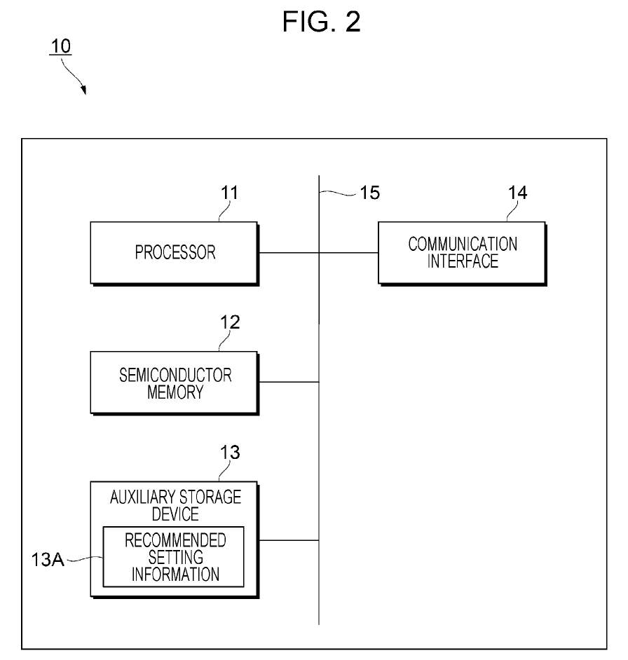

FIG. 2 is a diagram illustrating an exemplary hardware configuration of the security setting support server 10. The security setting support server 10 includes a processor 11, a semiconductor memory 12, an auxiliary storage device 13, a communication interface 14, and a signal line 15.

The processor 11 is a semiconductor integrated circuit that implements various functions through execution of programs. The programs include an operating system (OS), a unified extensible firmware interface (UEFI), and application programs.

The OS is a program for controlling the operations of the entire server.

The UEFI is a program that controls a server startup process. The application programs according to the present exemplary embodiment include a program for supporting security-related setting of the image forming apparatuses 20 in accordance with information about the usage locations and the installation environments.

The semiconductor memory 12 includes, for example, a read only memory (ROM) and a random access memory (RAM) used as a work area of the processor 11.

The auxiliary storage device 13 is composed of, for example, a hard disk drive or a semiconductor storage. The auxiliary storage device 13 is an example of a storage device.

In addition to the programs, recommended setting information 13A is stored in the auxiliary storage device 13. The recommended setting information 13A stores recommended security values (hereinafter also referred to as "recommended security") corresponding to combinations of usage locations and installation environments.

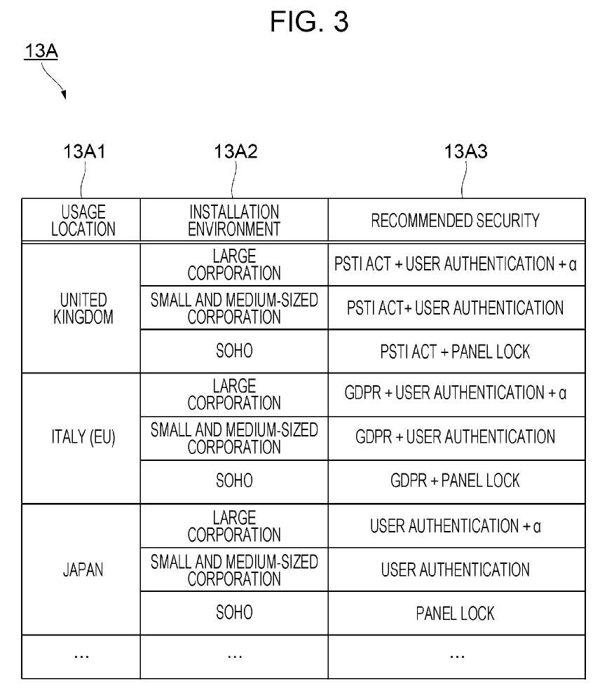

FIG. 3 is a diagram illustrating an example of data of recommended setting information 13A. The recommended setting information 13A includes usage location 13A1, installation environment 13A2, and recommended security 13A3.

The usage location 13A1 corresponds to a country or a region where image forming apparatuses 20 are used. FIG. 3 illustrates the United Kingdom, Italy, and Japan in the usage location 13A1. Italy is registered as one of the constituent countries of the EU.

The installation environment 13A2 represents classifications of environments in which the image forming apparatuses 20 are installed. In the case of FIG. 3, three types of installation environment 13A2, namely, large corporation, small and medium-sized corporation, and SOHO, are provided. However, the classifications illustrated in FIG. 3 are merely an example, and for example, classifications based on the number of users who use image forming apparatuses 20 or the number of registered users, and classifications based on the number of image forming apparatuses 20 managed by users are also possible.

The recommended security 13A3 corresponds to recommended security values (so-called default values) corresponding to the combinations of the usage location 13A1 and the installation environment 13A2. Even if the usage location 13A1 is the same, when the installation environment 13A2 is different, the recommended security value is different. In the recommended security 13A3, security setting candidates that comply with the laws and regulations of the usage location 13A1 are stored. In the present exemplary embodiment, setting candidates which take into account not only the usage location 13A1 but also the installation environment 13A2 are stored.

For example, when the usage location 13A1 is "United Kingdom" and the installation environment 13A2 is "large corporation", a combination of compliance with the PSTI Act, user authentication, and other parameters is recommended. The number of other parameters may be one or more. In FIG. 3, other parameters are represented by "α".

For example, when the usage location 13A1 is "United Kingdom" and the installation environment 13A2 is "small and medium-sized corporation", a combination of compliance with the PSTI Act and user authentication is recommended.

For example, when the usage location 13A1 is "United Kingdom" and the installation environment 13A2 is "SOHO", a combination of compliance with the PSTI Act and panel lock is recommended.

When the usage location 13A1 is "Italy" and the installation environment 13A2 is "large corporation", a combination of compliance with GDPR, user authentication, and other parameters is recommended.

For example, when the usage location 13A1 is "Italy" and the installation environment 13A2 is "small and medium-sized corporation", a combination of compliance with GDPR and user authentication is recommended.

For example, when the usage location 13A1 is "Italy" and the installation environment 13A2 is "SOHO", a combination of compliance with GDPR and panel lock is recommended.

When the usage location 13A1 is "Japan" and the installation environment 13A2 is "large corporation", a combination of user authentication and other parameters is recommended.

For example, when the usage location 13A1 is "Japan" and the installation environment 13A2 is "small and medium-sized corporation", user authentication is recommended.

For example, when the usage location 13A1 is "Japan" and the installation environment 13A2 is "SOHO", panel lock is recommended.

In general, higher security settings are recommended for larger entities.

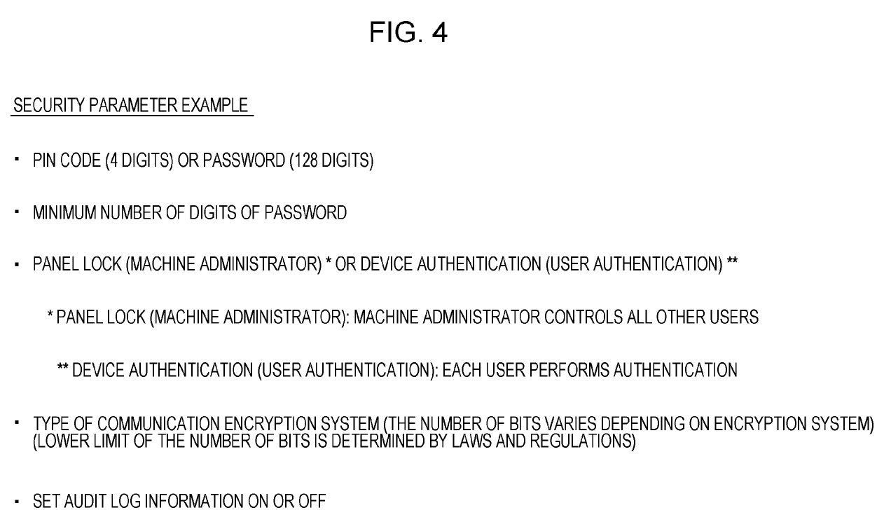

FIG. 4 is a diagram illustrating an example of parameters related to security.

One of the parameters is a setting related to whether the input of a personal identification number (PIN) code or a password is required to confirm a right to access a device. In the case of FIG. 4, the PIN code is, for example, a four digit number, and the password is, for example, a 128 digit character string. Passwords are generally more secure than PIN codes.

Another parameter specifies the minimum number of digits in a password. The minimum number of digits refers to the minimum number of digits that is to be satisfied by a password. The greater the number of digits, the stronger the security.

Another parameter is a setting as to whether to use a panel lock or to use device authentication (so-called user authentication). When a panel lock is adopted, an operation by an administrator is required to release the lock. In contrast, when device authentication is adopted, if an authentication operation is successfully performed on an image forming apparatus 20, the image forming apparatus 20 is allowed to be operated.

Another parameter is the type of encryption scheme for communication. The length of a key, that is, the number of bits, is determined by the encryption scheme. The lower limit of the number of bits is determined by laws and regulations.

Another parameter is whether the setting of audit log information is "ON" or "OFF". When the audit log information is "ON", an operation history is recorded. That is, an operation log is recorded.

The description returns to FIG. 2.

The communication interface 14 is a module that implements communication with external terminals. The communication interface 14 includes, for example, a module used in connection to a wired or wireless LAN. The communication interface 14 includes, for example, a Universal Serial Bus (USB) module. The communication interface 14 is also used for communication with the image forming apparatuses 20 (see FIG. 1).

These devices are connected to one another through the signal line 15 such as a bus.

### Hardware Configuration of Image Forming Apparatus 20

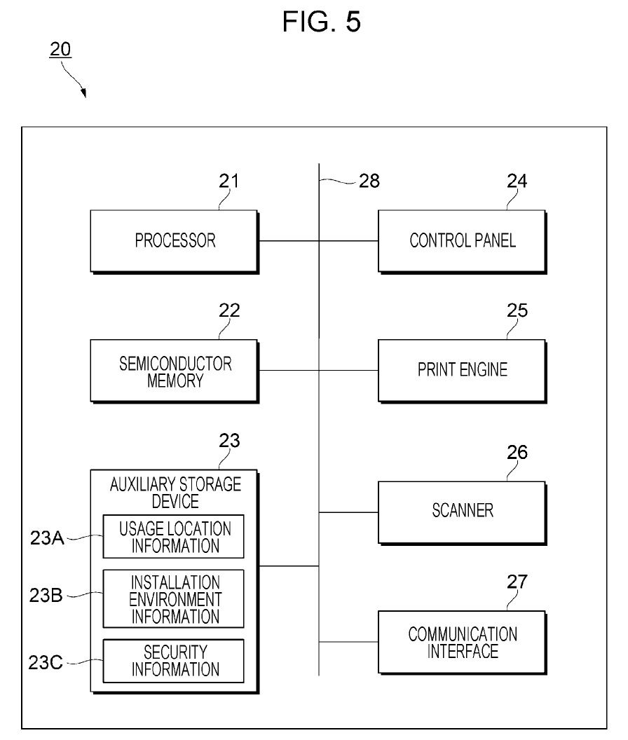

FIG. 5 is a diagram illustrating an exemplary hardware configuration of an image forming apparatus 20.

The image forming apparatus 20 includes a processor 21, a semiconductor memory 22, an auxiliary storage device 23, a control panel 24, a print engine 25, a scanner 26, a communication interface 27, and a signal line 28.

The processor 21 is a semiconductor integrated circuit that implements various functions through the execution of programs. The programs include firmware, a UEFI, and application programs.

The firmware is a program for controlling operations of the entire apparatus. The UEFI is a program that controls a device startup process.

The semiconductor memory 22 includes, for example, a ROM and a RAM used as a work area of the processor 21.

The auxiliary storage device 23 is composed of, for example, a hard disk drive or semiconductor storage. The auxiliary storage device 23 stores usage location information 23A, installation environment information 23B, and security information 23C in addition to the programs.

The usage location information 23A is information indicating the usage location of the image forming apparatus 20. The usage location information 23A may be manually set or may be automatically set by using an IP address.

The installation environment information 23B is information indicating the installation environment of the image forming apparatus 20. In the present exemplary embodiment, the installation environment information 23B is manually set by a user of the image forming apparatus 20. The installation environment information 23B may be automatically set by the security setting support server 10 (see FIG. 1).

The security information 23C is security-related settings employed by the image forming apparatus 20.

The control panel 24 is a device that receives user operations. The control panel 24 is provided with, for example, a touch panel, buttons, and switches. The touch panel is, for example, a device having a structure in which a capacitive translucent thin-film sensor is stacked on the surface of a display. The touch panel is an example of a device having both functions of an input device and an output device. The buttons and the switches are examples of mechanical controls. Hereinafter, various screens displayed on the touch panel are also referred to as operation screens.

The print engine 25 is a device that prints information on a sheet or another medium. The print engine 25 according to the present exemplary embodiment also executes various processes related to printing of information. For example, the print engine 25 also executes functions related to rasterization processing, density correction, sharpness correction, contrast correction, and background color removal. The mechanism of the print engine 25 varies depending on the printing system. For example, the mechanism of the print engine 25 is different between a photographic printing system and an inkjet system.

The scanner 26 is a device that optically reads information on a document. The scanner 26 supports either one or both of a system of moving a reading unit relative to a stationary document, and a system of moving a document relative to a stationary reading unit.

The communication interface 27 is a module that implements communication with external terminals. The communication interface 27 includes, for example, a module used in connection to a wired or wireless LAN.

The communication interface 27 includes, for example, a USB module or a near field communication (NFC) module. The communication interface 27 is used in communication with a terminal (for example, a smartphone) connected to the network N. In the present exemplary embodiment, the communication interface 27 is used in communication with the security setting support server 10 (see FIG. 1).

These devices are connected to one another through the signal line 28 such as a bus.

### Processing Sequence

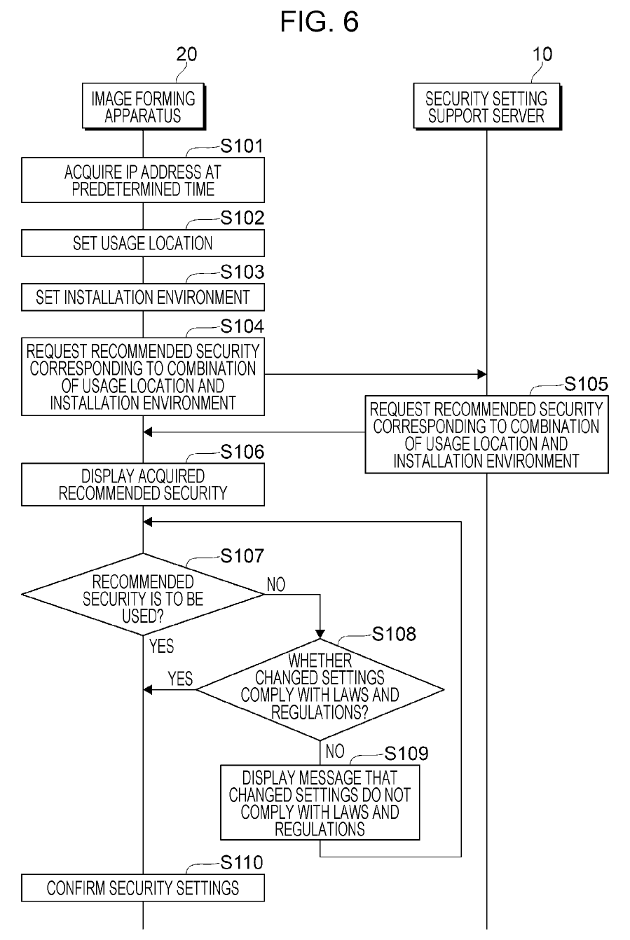

FIG. 6 is a diagram illustrating an exemplary processing sequence related to security setting of an image forming apparatus 20. The symbol S illustrated in FIG. 6 denotes a step.

The processing operation of the security setting support server 10 proceeds through execution of a program by the processor 11 (see FIG. 2). The processing operation of the image forming apparatus 20 proceeds through execution of a program by the processor 21 (see FIG. 5).

In the case of FIG. 6, the image forming apparatus 20 acquires an IP address at a predetermined time (step 101). Examples of the predetermined time include a startup time of the image forming apparatus 20, a time at which an elapsed time since the startup exceeds a threshold (first threshold), and a time at which an elapsed time since the main power is turned off exceeds a threshold (second threshold).

Next, the image forming apparatus 20 sets a usage location (step 102). If an IP address is successfully acquired, the image forming apparatus 20 sets a usage location based on the IP address. If the image forming apparatus 20 fails to acquire an IP address, the image forming apparatus 20 receives input of a usage location from a user. The information about the usage location which is set using the IP address is an example of first usage location information. The information about the usage location which is input by the user is an example of second usage location information.

Next, the image forming apparatus 20 sets an installation environment (step 103). In the present exemplary embodiment, the image forming apparatus 20 receives input of an installation environment from the user.

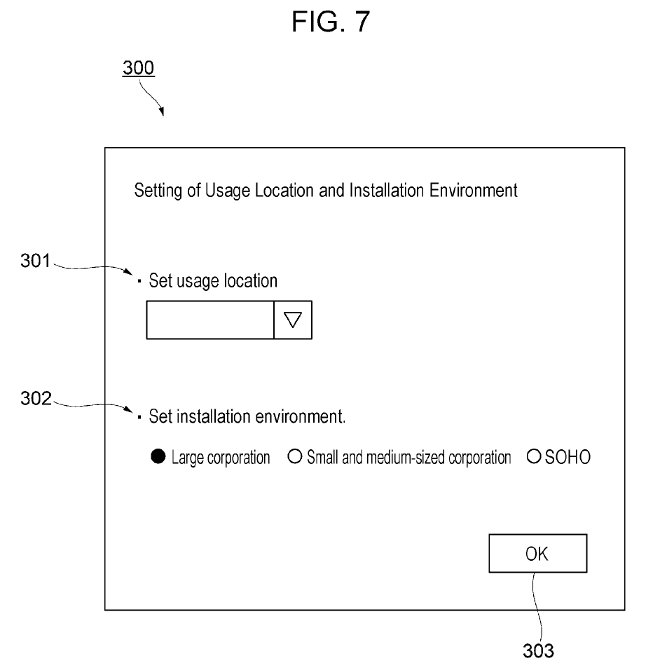

FIG. 7 is a diagram illustrating an example of an operation screen 300 used to set a usage location and an installation environment. The operation screen 300 is provided with a usage location setting field 301, an installation environment setting field 302, and an OK button 303.

In the case of FIG. 7, the usage location setting field 301 receives setting of a usage location in a pull-down menu format. When a usage location is set by using the IP address, the set usage location is displayed by default. However, the user may change the usage location displayed by default.

In the case of FIG. 7, the installation environment setting field 302 receives setting of an installation environment in a radio button format. In FIG. 7, a radio button corresponding to large corporation has been selected. Since the buttons are radio buttons, only one button is in the selected state.

When an operation on the OK button 303 is received, the usage location and the installation environment have been set.

The description returns to FIG. 6.

When setting of a usage location and an installation environment is completed, the image forming apparatus 20 accesses the security setting support server 10 and requests recommended security corresponding to a combination of the usage location and the installation environment (step 104).

The security setting support server 10 refers to, for example, the recommended setting information 13A (see FIG. 2), and notifies the recommended security corresponding to the combination of the usage location and the installation environment (step 105).

The image forming apparatus 20 displays the acquired recommended security (step 106). The recommended security is a set of recommended parameters determined in accordance with the laws and regulations of the usage location and the installation environment. This causes the user to be relieved of a task of setting each of all of the settable parameters. Additionally, since the recommended security complies with the laws and regulations of the usage location, the user does not need to set each parameter so that the parameter satisfies the laws and regulations of the usage location.

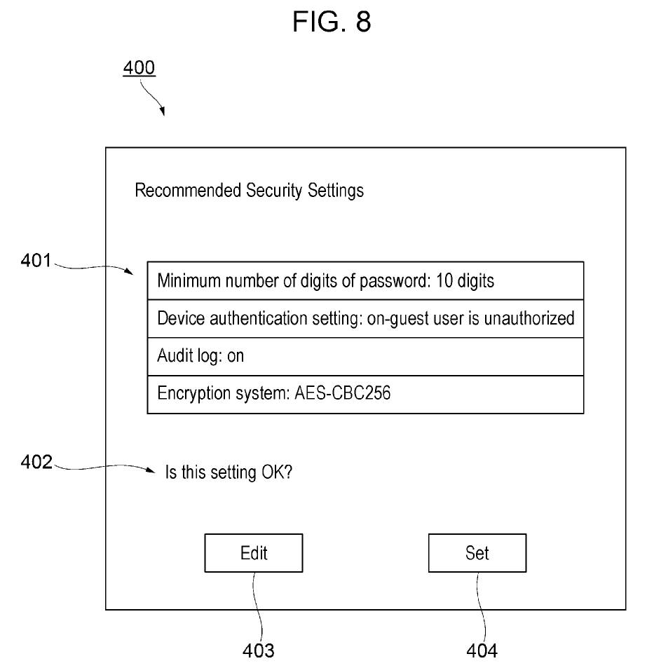

FIG. 8 is a diagram illustrating an example of a display screen 400 of recommended security. The display screen 400 is provided with a recommended parameter set 401, a description 402, an edit button 403, and a setting button 404.

In the case of FIG. 8, the followings are illustrated as the recommended parameter set 401: the minimum number of digits of a password is 10; the device authentication setting is ON; the audit log setting is ON; and the encryption system is "AES-CBC256".

In the device authentication, it is also illustrated that a guest user does not have authority of authentication. The recommended parameter set 401 satisfies not only the laws and regulations of the usage location but also the security level for the installation environment.

The description 402 describes, for example, the determination that is to be made by the user. In the case of FIG. 8, the description is "Is this setting OK?" The description 402 may include a description about an operation or the like requested from the user. For example, a message such as "If this setting is OK, please operate the setting button. If it is to be changed, please operate the edit button." may be included.

When the edit button 403 is operated, for example, the recommended security may be edited. However, edit to settings that do not comply with the laws and regulations is not permitted. In edit of the recommended security, the display screen 400 may be used as it is, or a dedicated edit screen may be used. When a dedicated edit screen is used, parameters other than the recommended parameter set 401 may be editable.

When the setting button 404 is operated, the settings in the recommended parameter set 401 are confirmed. Specifically, the recommended parameter set 401 is registered in the security information 23C (see FIG. 5).

The description returns to FIG. 6.

When the display screen 400 is displayed, the image forming apparatus 20 determines whether to use recommended security (step 107).

When recommended security is not used (for example, when the edit button 403 (see FIG. 8) is operated), a negative result is obtained in step 107. The case of no use of the recommended security includes, for example, a change for making the security higher than that of the recommended parameters. The case of no use of the recommended security includes a change for making the security lower than that of the recommended parameters.

If a negative result is obtained in step 107, the image forming apparatus 20 receives a change of the security settings, and then determines whether the settings after the change comply with the laws and regulations (step 108).

If the settings after the change do not comply with the laws and regulations, a negative result is obtained in step 108.

In this case, the image forming apparatus 20 displays a message that the settings after the change do not comply with the laws and regulations (step 109). After that, the image forming apparatus 20 returns to step 107. In the case of FIG. 6, the changed settings are checked only from the viewpoint of the laws and regulations. Therefore, in the case of FIG. 6, the changed settings are not checked from the viewpoint of the installation environment. However, the changed settings may be checked from the viewpoint of not only the laws and regulations but also the installation environment.

If the settings after the change comply with the laws and regulations, a positive result is obtained in step 108.

When the setting button 404 (see FIG. 8) is operated on the display screen 400 (see FIG. 8) of the recommended security, a positive result is obtained in step 107. In this case, or if a positive result is obtained in step 108, the image forming apparatus 20 confirms the security settings (step 110).

### Summary

Use of the security management system 1 (see FIG. 1) facilitates security settings that satisfy the the laws and regulations of the usage location of the image forming apparatus 20 and the installation environment. For example, when the usage location may be set from the IP address, a user may receive presentation of the recommended parameter set 401 (see FIG. 8) only by inputting the installation environment.

When an operation of setting security that does not comply with the laws and regulations of the usage location is received, the user is notified of the fact. In this case, the setting operation is not accepted as a valid operation, and the security setting is not completed. Thus, the setting may be supported so that the user does not set a wrong security that does not comply with the laws and regulations of the usage location. As a result, the image forming apparatus 20 is prevented from being used in a security state which does not comply with the laws and regulations.

### Second Exemplary Embodiment

According to the first exemplary embodiment, the usage location acquired from the IP address is displayed by default in the usage location setting field 301 (see FIG. 7). However, the usage location acquired from the IP address may be used to verify a user's erroneous input of a usage location.

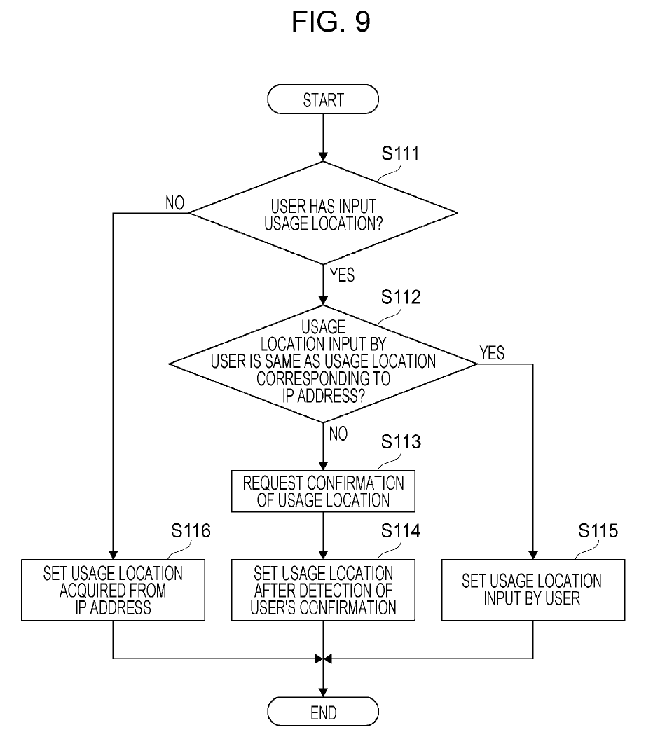

FIG. 9 is a flowchart illustrating an exemplary processing operation performed in relation to setting of a usage location. The flowchart illustrated in FIG. 9 is executed, for example, in step 102 (see FIG. 6).

First, the image forming apparatus 20 determines whether the user has input a usage location (step 111). That is, the image forming apparatus 20 determines whether the usage location has been manually input.

If the user's input of the usage location is recognized, a positive result is obtained in step 111. In this case, the image forming apparatus 20 determines whether the usage location, which is input by the user, is the same as the usage location corresponding to the IP address (step 112). The usage location, which is input by the user here, is an example of second usage location information.

If the usage location, which is input by the user, is different from the usage location corresponding to the IP address, a negative result is obtained in step 112. In this case, the image forming apparatus 20 requests confirmation of the usage location (step 113). For example, the image forming apparatus 20 changes the color of the characters of the usage location, which has been set in the usage location setting field 301 (see FIG. 7), to red to call the user's attention. In addition, a warning message for requesting confirmation of the usage location, a pop-up for requesting confirmation of the usage location, or another screen for requesting confirmation of the usage location may be displayed.

After detecting the user's confirmation, the image forming apparatus 20 sets the usage location (step 114). The confirmation includes, for example, an operation of changing to the usage location acquired from the IP address, and an operation on a button indicating that the input usage location is correct.

In contrast, if the usage location, which is input by the user, is the same as the usage location corresponding to the IP address, a positive result is obtained in step 112. In this case, the image forming apparatus 20 sets the usage location which is input by the user (step 115).

If the user does not input a usage location, a negative result is obtained in step 111. In this case, the image forming apparatus 20 sets the usage location acquired from the IP address (step 116).

Use of the above-described mechanism prevents erroneous setting of a usage location, which is indispensable for setting recommended security. As a result, the security setting complying with the laws and regulations of the usage location is achieved.

### Third Exemplary Embodiment

The usage location of the image forming apparatus 20 may not be changed after installation. However, the usage location of the image forming apparatus 20 may be changed, for example, due to a relocation of the office.

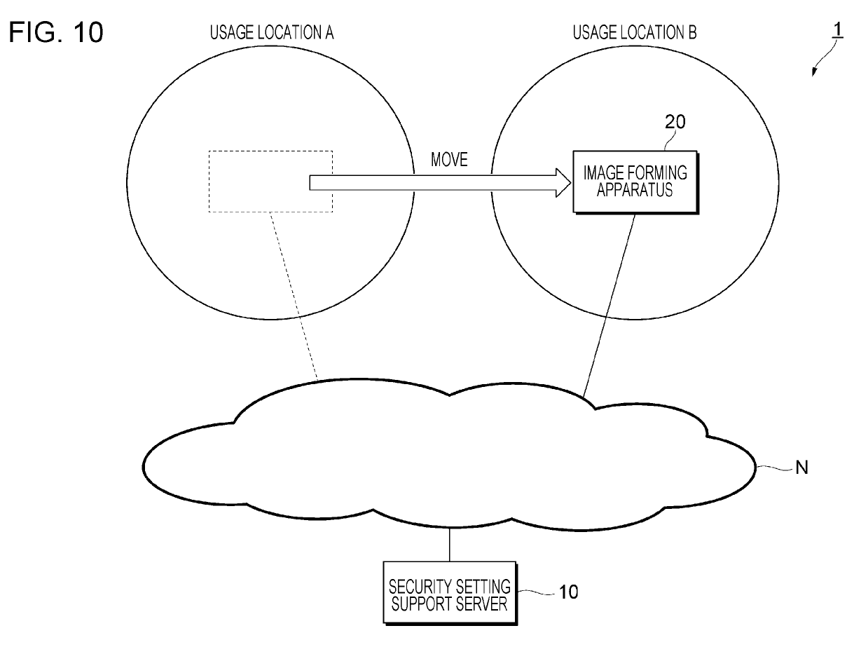

FIG. 10 is a diagram illustrating a change of the usage location due to a move. In FIG. 10, parts corresponding to those in FIG. 1 are denoted by corresponding reference numerals. The image forming apparatus 20 illustrated in FIG. 10 is transferred from Usage location A to Usage location B after installation.

When the laws and regulations applied in Usage location A are the same as those applied in Usage location B, there is no need to change the security settings.

However, when the laws and regulations applied in Usage location A are different from those applied in Usage location B, it is necessary to consider changing the security settings.

For example, when the laws and regulations applied in Usage location B are looser than those applied in Usage location A, the security settings, which have been set in Usage location A, may be used as they are. However, the security settings may be changed to looser settings than those for Usage location A in accordance with the laws and regulations applied in Usage location B.

When the laws and regulations applied in Usage location B are stricter than those applied in Usage location A, it is essential to change the security settings to comply with the laws and regulations of Usage location B.

As described above, a change of the usage location of an image forming apparatus 20 is one of the reasons that the security settings do not comply with the laws and regulations of the usage location.

However, unlike the case where a new image forming apparatus 20 is introduced, a change of security settings may be overlooked.

Accordingly, in the present exemplary embodiment, a function of periodically checking whether the current security settings comply with the laws and regulations of the usage location will be described.

### First Processing Operation

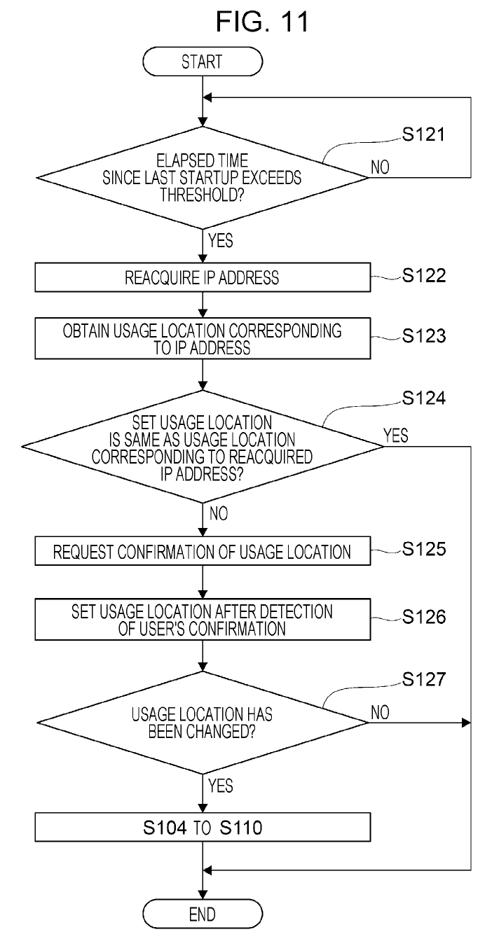

FIG. 11 is a flowchart illustrating an exemplary operation of confirming a usage location. In FIG. 11, parts corresponding to those in FIG. 6 are denoted by corresponding reference numerals.

In the case of FIG. 11, the image forming apparatus 20 (see FIG. 1) determines whether the elapsed time since the last activation exceeds a threshold (step 121). The activation is not limited to activation immediately after the main power supply is turned on, and may include recovery from a sleep state.

The determination criterion is an example of a predetermined condition. Other determination criteria include whether or not the elapsed time since the last determination exceeds a threshold, whether or not the current date and time matches a preset month or day of the week, and whether or not a prescheduled time has come.

If the elapsed time since the last activation does not exceed the threshold, a negative result is obtained in step 121. In this case, the image forming apparatus 20 repeats the determination in step 121.

In contrast, if the elapsed time since the last activation exceeds the threshold, a positive result is obtained in step 121. In this case, the image forming apparatus 20 reacquires the IP address (step 122). Next, the image forming apparatus 20 acquires a usage location corresponding to the IP address (step 123). Thus, the usage location of the image forming apparatus 20 at the current time is identified.

Subsequently, the image forming apparatus 20 determines whether the set usage location is the same as the usage location corresponding to the reacquired IP address (step 124). The set usage location is stored in the auxiliary storage device 23 (see FIG. 5) as usage location information 23A (see FIG. 5).

If the set usage location is the same as the usage location corresponding to the reacquired IP address, a positive result is obtained in step 124. In this case, there is no need to change the security settings. Thus, the image forming apparatus 20 ends the current processing operation without issuing any notification.

In contrast, if the set usage location is different from the usage location corresponding to the reacquired IP address, a negative result is obtained in step 124. In this case, the image forming apparatus 20 requests confirmation of the usage location (step 125). For example, the image forming apparatus 20 transmits an email or a message to the administrator of the image forming apparatus 20. In addition, the image forming apparatus 20 may display, on the control panel 24 (see FIG. 5), a message or the like for requesting confirmation of the usage location.

After detecting the user's confirmation, the image forming apparatus 20 sets the usage location (step 126). The confirmation includes confirmation of change of the usage location and confirmation of maintaining the current usage location. The change of the usage location includes change to the usage location acquired from the IP address and change to the usage location which is input by an administrator or the like.

Next, the image forming apparatus 20 determines whether the usage location has been changed (step 127).

If the current usage location is to be used as it is, a negative result is obtained in step 127. In this case, the image forming apparatus 20 ends the current processing operation without issuing any notification.

In contrast, if the usage location has been changed, a positive result is obtained in step 127. In this case, the image forming apparatus 20 proceeds to a security resetting process in accordance with the current usage location. That is, the processing operations from step 104 to step 110 (see FIG. 6) are performed.

### Second Processing Operation

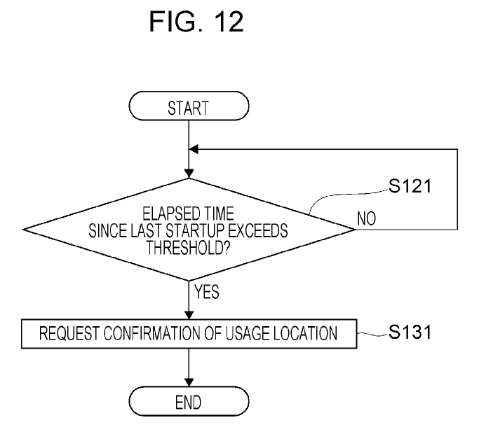

FIG. 12 is a flowchart illustrating another exemplary operation of confirming the usage location. In FIG. 12, parts corresponding to those in FIG. 11 are denoted by corresponding reference numerals.

Also in the case of the processing operation illustrated in FIG. 12, the image forming apparatus 20 determines whether the elapsed time since the last activation exceeds the threshold (step 121).

If the elapsed time since the last activation does not exceed the threshold, a negative result is obtained in step 121. In this case, the image forming apparatus 20 repeats the determination in step 121.

If the elapsed time since the last activation exceeds the threshold, the image forming apparatus 20 requests confirmation of the usage location (step 131). The usage location may be confirmed, for example, by the same method as in step 125 (see FIG. 11). In this operation of confirming a usage location, the image forming apparatus 20 performs the operation until confirmation is requested. After that, the operation is left to the user's discretion. For example, the user confirms the usage location or sets the usage location. If the user sets the usage location, steps 104 to 110 (see FIG. 6) are executed.

### Third Processing Operation

In the first and second processing operations described above, whether the elapsed time since the last activation exceeds the threshold is used as a criterion for determining whether the predetermined condition is satisfied. However, whether the elapsed time since the main power supply is turned off exceeds a threshold may be used as the determination criterion.

For example, in the case of moving an office, the power cable of an image forming apparatus 20 is disconnected from a power outlet or a power tap. In this case, the main power supply of the image forming apparatus 20 is turned off.

However, the main power supply may be off for a short time due to a power failure or the like. However, except for a case due to a disaster or the like, the time of the off state is shorter than the time in the case of moving an office or the like.

In the case of moving an office or the like, the main power supply may be off for several hours to several days. The time during which the main power supply is off depends on the amount of baggage to be moved to the new place and the distance of the move. For example, when a border is close, the laws and regulations of the usage location may change within several hours.

In this exemplary operation, the threshold is set to, for example, three hours, and the off state of the main power supply exceeding the threshold is regarded as occurrence of an event involving change of the laws and regulations.

When the determination criterion is satisfied, the IP address may be acquired again as in step 122 (see FIG. 11), or the administrator may be requested to confirm the usage location as in step 131 (see FIG. 12).

### Fourth Exemplary Embodiment

In the first to third exemplary embodiments described above, it is assumed that the installation environment set by a user is correct or does not change.

However, there may be the case where a user makes a mistake in setting, or the case where the scale of the user changes while the user uses image forming apparatuses 20. For example, the number of image forming apparatuses 20 used by a user may increase or decrease, or the number of employees registered in image forming apparatuses 20 may increase or decrease.

When such an event occurs, there is a possibility that the security settings at the time of installation of image forming apparatuses 20 do not conform to the current state.

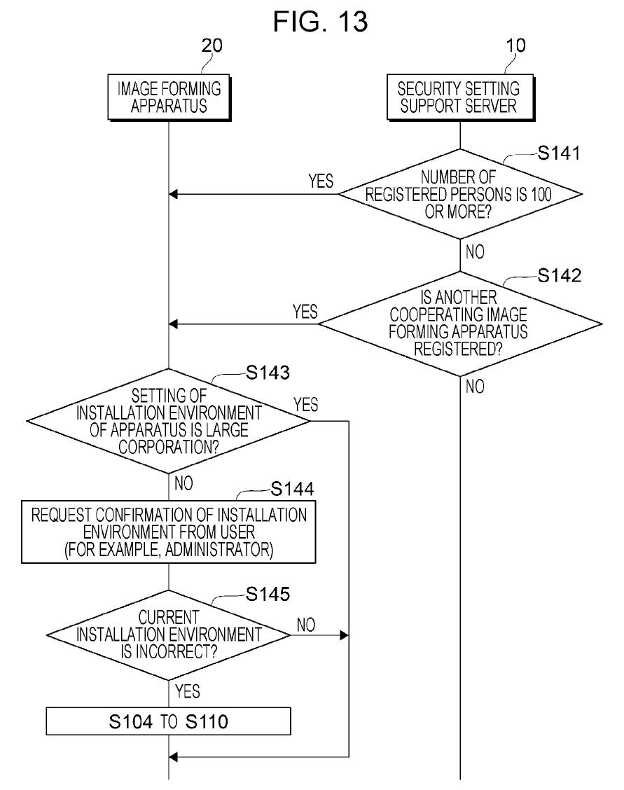

FIG. 13 is a flowchart illustrating an exemplary processing sequence under the assumption of a review of security in accordance with a change in the business environment of a user after installation. In FIG. 13, parts corresponding to those in FIG. 6 are denoted by corresponding reference numerals.

In this exemplary embodiment, the security setting support server 10 starts the processing operation. The security setting support server 10 starts the processing operation at a predetermined time for each user who uses image forming apparatuses 20 or the security setting support service. Examples of the predetermined time include a time after a predetermined time period has elapsed since start of use of the security setting support service and a time after a predetermined time period has elapsed since the last operation.

First, the security setting support server 10 determines whether the number of registered persons is 100 or more (step 141). The number of registered persons includes, for example, the number of persons registered in the image forming apparatus 20 which is the target of the process and the total number of registered users who use the image forming apparatus 20 which is the target of the process.

A threshold of "One hundred persons" is an exemplary threshold for distinguishing large corporation from others. As in the above-described exemplary embodiments, when large corporation, small and medium-sized corporation, and SOHO are to be distinguished from each other, the number of persons corresponding to each corporation type is used as a threshold.

When the number of registered persons is 100 or more, a positive result is obtained in step 141. In this case, the security setting support server 10 notifies the image forming apparatus 20 of a message indicating this.

In contrast, if the number of registered persons is less than 100, a negative result is obtained in step 141. In this case, the security setting support server 10 determines whether another image forming apparatus 20 that cooperates with the image forming apparatus 20 is registered (step 142). Examples of another image forming apparatus 20 that cooperates with the image forming apparatus 20 include an image forming apparatus 20 used by the same user registered in management information. Examples of another image forming apparatus 20 that cooperates with the image forming apparatus 20 include another image forming apparatus 20 used on the same floor.

In FIG. 13, it is assumed that large corporation uses multiple image forming apparatuses 20, but other types of corporations use only one image forming apparatus 20.

As in the above-described exemplary embodiments, when large corporation, small and medium-sized corporation, and SOHO are to be distinguished from each other, the number of apparatuses corresponding to each type of corporation may be used as the threshold.

If there is another image forming apparatus 20 that cooperates with the image forming apparatus 20, a positive result is obtained in step 142. In this case, the security setting support server 10 notifies the image forming apparatus 20 of a message indicating this.

If there is no other image forming apparatuses 20 that cooperate with the image forming apparatus 20, a negative result is obtained in step 142. In this case, the security setting support server 10 ends the current operation.

If a positive result is obtained in step 141 or step 142 (when a notification of being large corporation is received from the security setting support server 10), the image forming apparatus 20 determines whether setting of the installation environment of the image forming apparatus 20 is "large corporation" (step 143).

If the setting of the installation environment of the image forming apparatus 20 is large corporation, a positive result is obtained in step 143. In this case, since there is no change of the setting, the image forming apparatus 20 ends the current processing operation.

In contrast, if the setting of the installation environment of the image forming apparatus 20 is not large corporation, a negative result is obtained in step 143. In this case, the image forming apparatus 20 requests the user (for example, the administrator) to confirm the installation environment (step 144). Information for contacting the administrator (for example, a mail address and a telephone number) is stored in the image forming apparatus 20.

Alternatively, a message or a screen for requesting confirmation of the installation environment may be displayed on the control panel 24 (see FIG. 5), and the administrator may be notified via the employee.

Next, the image forming apparatus 20 determines whether the current installation environment is incorrect (step 145). The administrator determines whether the setting is incorrect. That is, the image forming apparatus 20 determines whether the administrator's input or selection indicates that the current setting of the installation environment is "incorrect" or "correct".

If the current installation environment is correct, a negative result is obtained in step 145. This case includes, for example, the case where the user does not want to change the current security setting for some reason. In this case, the image forming apparatus 20 ends the processing operation without executing the sequence of changing the security settings.

In contrast, if the installation environment is incorrect, a positive result is obtained in step 145. In this case, the image forming apparatus 20 transitions to a security resetting process in accordance with the current installation environment. That is, the processing operations of steps 104 to 110 in FIG. 6 are performed.

Consequently, the security level of the image forming apparatus 20 may be adjusted in accordance with change of the installation environment. However, compliance with the laws and regulations of the usage location is a prerequisite.

In the description of the present exemplary embodiment, it is assumed that the classification of the installation environment is changed from small and medium-sized corporation to large corporation. However, the classification of the installation environment is also changed from SOHO to small and medium-sized corporation. In addition, the classification of the installation environment is also changed from large corporation to small and medium-sized corporation, or from small and medium-sized corporation to SOHO.

In these cases, if a negative result is obtained in step 141 and step 142, the image forming apparatus 20 may be notified. In step 143, the image forming apparatus 20 may determine whether the current setting of the installation environment is small and medium-sized corporation or SOHO.

### Fifth Exemplary Embodiment

In the above-described exemplary embodiments, the installation environment is managed on a corporation-scale basis, and a recommended parameter set prepared in accordance with a corporation scale is recommended to an image forming apparatus 20.

However, for example, even if the classification of the corporation scale is the same, some users are satisfied with the recommended parameter set; some users desire settings at a higher level; and some users desire settings at a lower level than the recommended parameter set.

The present exemplary embodiment makes it possible to set a parameter set at a security level desired by a user regardless of the corporation scale.

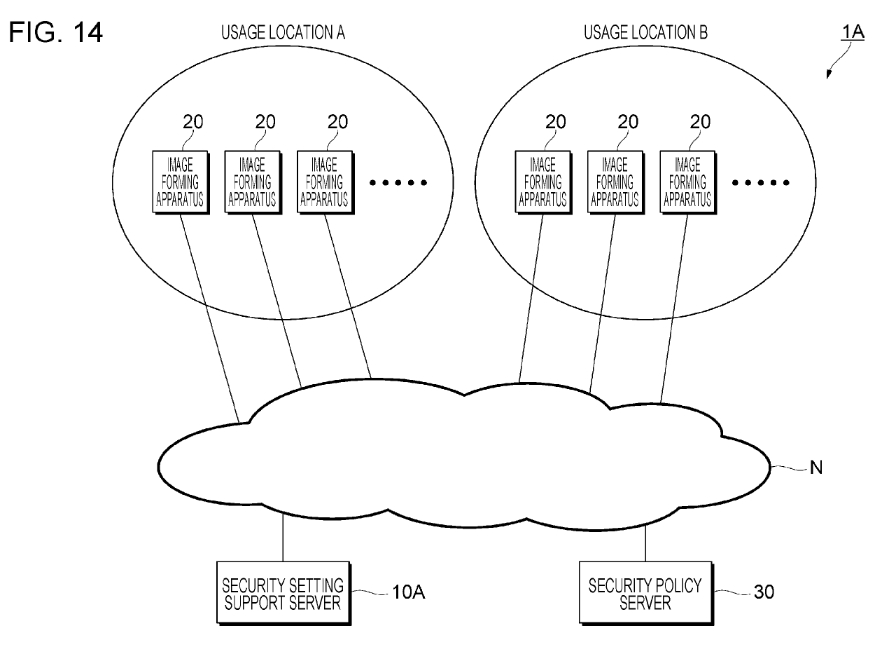

FIG. 14 is a diagram illustrating an example of a security management system 1A. In FIG. 14, parts corresponding to those in FIG. 1 are denoted by corresponding reference numerals.

A security policy server 30 is added to the security management system 1A illustrated in FIG. 14.

The security policy server 30 is a server that manages recommended parameter sets corresponding to security policies. Security policy refers to a guideline on user security. Examples of the guideline include whether to employ standard security, higher security than the standard, or lower security than the standard.

In the present exemplary embodiment, only one security policy server 30 is provided in the security management system 1A, and collectively manages the security policies of multiple users.

However, the security policy server 30 may be provided for each user who uses the security setting support service. The security policy server 30 may also be regarded, by itself, as an information processing system.

In the present exemplary embodiment, a security setting support server 10A stores only recommended security that complies with the laws and regulations of usage locations.

### Configuration of Terminal

### Hardware Configuration of Security Setting Support Server 10A

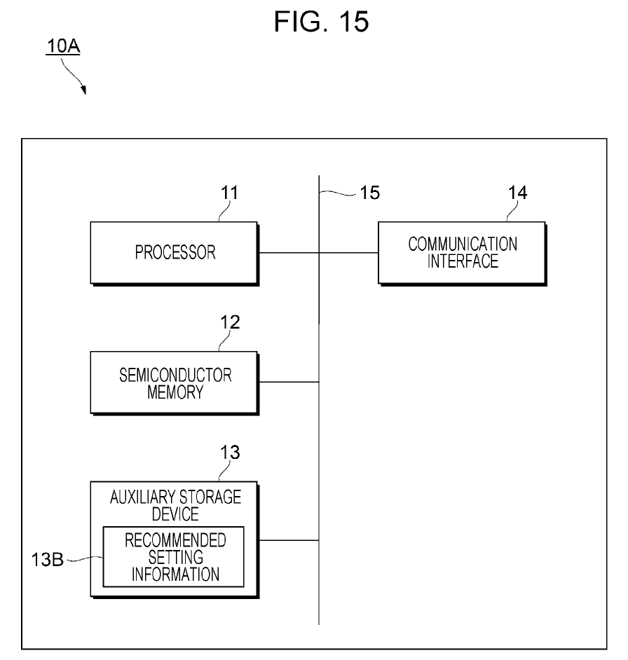

FIG. 15 illustrates an exemplary hardware configuration of the security setting support server 10A. In FIG. 15, parts corresponding to those in FIG. 2 are denoted by corresponding reference numerals.

The security setting support server 10A illustrated in FIG. 15 includes the processor 11, the semiconductor memory 12, the auxiliary storage device 13, the communication interface 14, and the signal line 15. The auxiliary storage device 13 stores recommended setting information 13B.

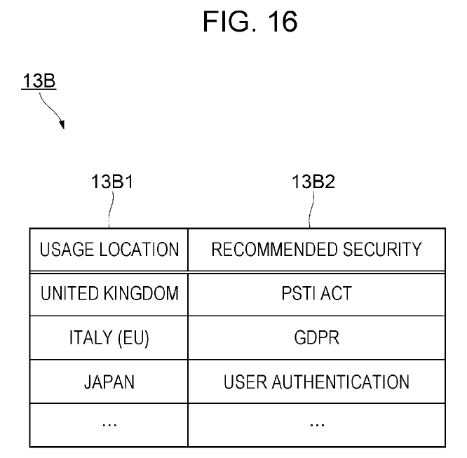

FIG. 16 illustrates an example of the recommended setting information 13B. The recommended setting information 13B illustrated in FIG. 16 includes usage location 13B1 and recommended security 13B2.

The usage location 13B1 corresponds to a country or region where image forming apparatuses 20 are used. Also in the case of FIG. 16, the United Kingdom, Italy, and Japan are illustrated as the usage location 13B1.

The recommended security 13B2 corresponds to a recommended value (a so-called default value) of security that complies with the laws and regulations applied to usage location 13B1.

### Hardware Configuration of Security Policy Server 30

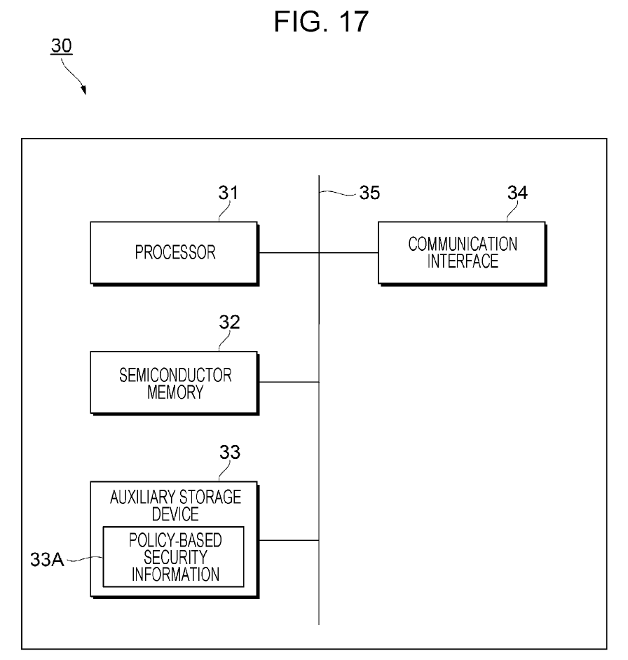

FIG. 17 is a diagram illustrating an exemplary hardware configuration of the security policy server 30. The security policy server 30 includes a processor 31, a semiconductor memory 32, an auxiliary storage device 33, a communication interface 34, and a signal line 35.

The processor 31 is a semiconductor integrated circuit that implements various functions through execution of programs. The programs include an OS, a UEFI, and application programs.

The OS is a program for controlling the operations of the entire server. The UEFI is a program that controls a server startup process.

The semiconductor memory 32 includes, for example, a ROM and a RAM used as a work area of the processor 31.

The auxiliary storage device 33 is formed of, for example, a hard disk drive or a semiconductor storage. The auxiliary storage device 33 stores policy-based security information 33A in addition to programs.

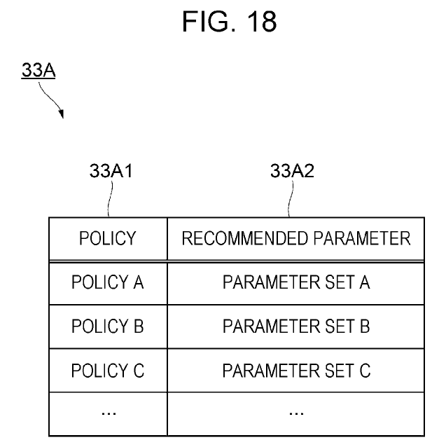

FIG. 18 illustrates an example of the policy-based security information 33A. The policy-based security information 33A illustrated in FIG. 18 includes policy 33A1 and recommended parameter 33A2.

FIG. 18 illustrates three types of policies A, B, and C.

For example, the security level of policy A is "high"; the security level of policy B is "medium"; and the security level of policy C is "low". The level, "medium", means standard security level; "high" means a higher level than the standard security; and "low" means a lower level than the standard security.

It should be noted that these classifications are for convenience of description and, in practice, can be defined from various viewpoints.

In the recommended parameter 33A2, recommended parameter sets corresponding to policies are stored. For example, parameter set A is stored for policy A; parameter set B is stored for policy B; and parameter set C is stored for policy C.

The communication interface 34 (see FIG. 17) is a module that implements communication with external terminals. The communication interface 34 includes, for example, a module used in connection to a wired or wireless LAN. In the present exemplary embodiment, the communication interface 34 is used in communication with the image forming apparatuses 20 (see FIG. 1).

These devices are connected to one another through the signal line 35 such as a bus (see FIG. 17).

### Processing Sequence

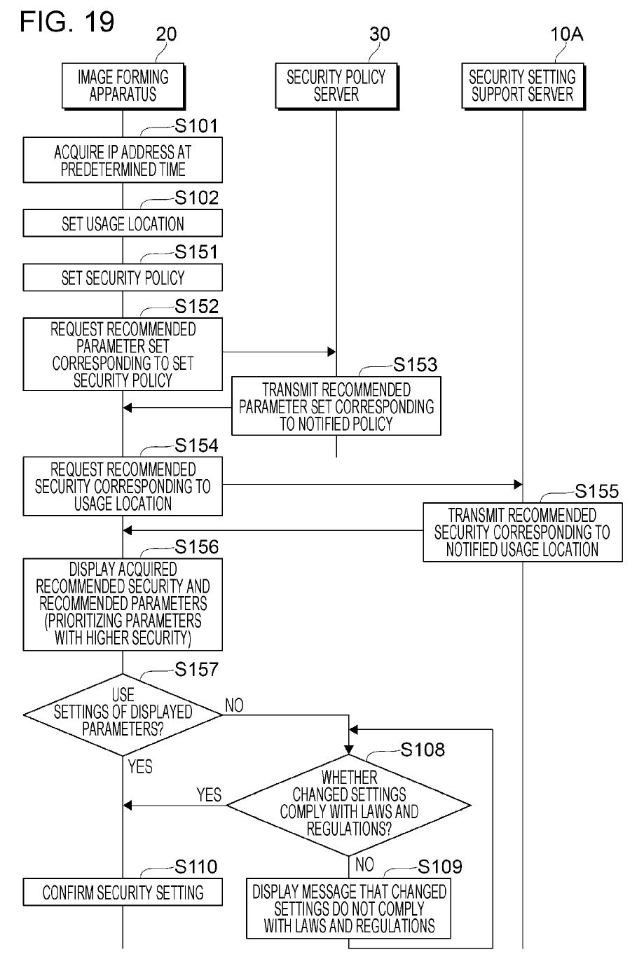

FIG. 19 is a diagram illustrating an exemplary processing sequence related to security setting of an image forming apparatus 20. In FIG. 19, parts corresponding to those in FIG. 6 are denoted by corresponding reference numerals.

Also in the present exemplary embodiment, the image forming apparatus 20 acquires an IP address at a predetermined time (step 101).

Next, the image forming apparatus 20 sets a usage location (step 102).

Next, the image forming apparatus 20 sets a security policy (step 151). The security policy is an example of installation environment information. The security policy is set through the control panel 24 (see FIG. 5). For example, security policy candidates are displayed in the installation environment setting field 302 (see FIG. 7).

Next, the image forming apparatus 20 requests a recommended parameter set corresponding to the set security policy from the security policy server 30 (step 152).

In response to this, the security policy server 30 refers to the policy-based security information 33A (see FIG. 18) and transmits the recommended parameter set corresponding to the notified policy (step 153).

Next, the image forming apparatus 20 requests recommended security corresponding to the usage location from the security setting support server 10A (step 154).

In response to this, the security setting support server 10A refers to, for example, the recommended setting information 13B (see FIG. 16), and notifies the recommended security corresponding to the usage location (step 155).

The image forming apparatus 20 displays the recommended security and recommended parameters which are acquired (step 156). However, a parameter set with higher security is prioritized.

After that, the image forming apparatus 20 determines whether to use the displayed parameter settings (step 157).

The subsequent processing operations are the same as those in the first exemplary embodiment. That is, step 108 to step 110 are executed.

As described above, this mechanism facilitates setting security that satisfies the security-related policy of the user of an image forming apparatus 20 while complying with the laws and regulations of the usage location.

### Sixth Exemplary Embodiment

After start of use of an image forming apparatus 20, the usage location may be changed, or the scale of the user who uses the image forming apparatus 20 may be changed. For these cases, the above exemplary embodiments describe mechanisms for adapting the security settings of an image forming apparatus 20 to the current state.

A change of the security settings to be applied after start of use of an image forming apparatus 20 is required due to enforcement of new laws and regulations or amendment of laws and regulations. However, the mechanisms of the above-described exemplary embodiments do not assume a change in laws and regulations.

### First Processing Operation

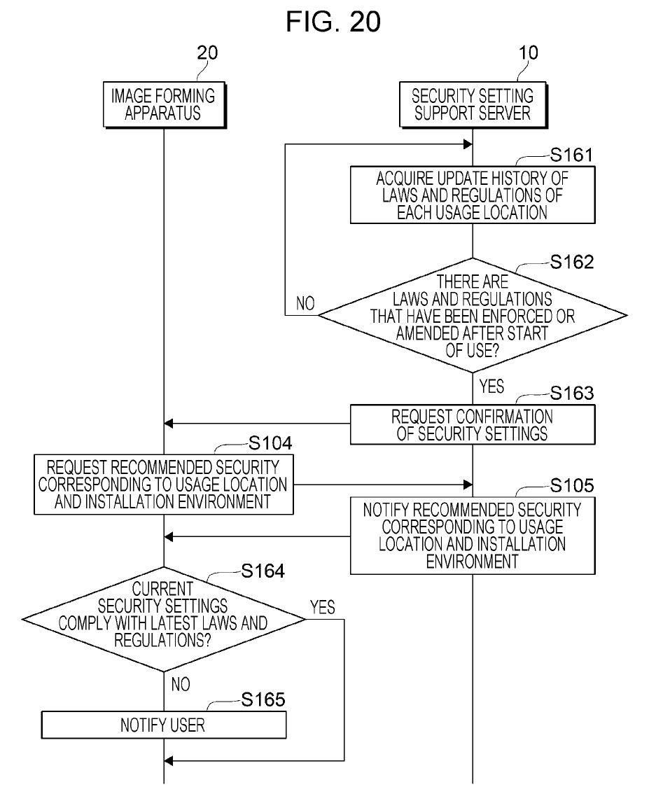

FIG. 20 is a diagram illustrating an exemplary processing sequence related to security setting of an image forming apparatus 20. In FIG. 20, parts corresponding to those in FIG. 6 are denoted by corresponding reference numerals.

The security setting support server 10 illustrated in FIG. 20 acquires an update history of laws and regulations for each usage location (step 161). In the present exemplary embodiment, step 161 is executed, for example, at a predetermined time. The predetermined time is, for example, the first day of each month. However, the acquisition process of step 161 may be executed at any time.

Next, the security setting support server 10 determines whether there are any laws and regulations that have been enforced or amended after the start of use (step 162). The amendment of the laws and regulations before the start of use has been dealt with when the image forming apparatus 20 is installed. Therefore, the determination in step 162 is performed for each image forming apparatus 20 which is to be managed.

If there are no such laws and regulations, a negative result is obtained in step 162. If a negative result is obtained in step 162 for all of the image forming apparatuses 20, the security setting support server 10 returns the process to step 161.

In contrast, if there are laws and regulations that have been enforced or amended after the start of use, a positive result is obtained in step 162. In this case, the security setting support server 10 requests a corresponding image forming apparatus 20 to confirm the security settings (step 163). However, this request may be executed in association with a firmware update notification.

Upon receiving the notification, the image forming apparatus 20 accesses the security setting support server 10 and requests recommended security corresponding to the usage location and the installation environment (step 104).

In response to this, the security setting support server 10 refers to, for example, the recommended setting information 13A (see FIG. 2), and notifies the recommended security corresponding to the usage location and the installation environment (step 105).

Upon receiving the notification, the image forming apparatus 20 determines whether the current security settings comply with the latest laws and regulations (step 164). Specifically, the image forming apparatus 20 determines whether the settings of the security-related parameters cover settings lower than the notified recommended parameter set.

If the current security settings comply with the latest laws and regulations, a positive result is obtained in step 164. In this case, the image forming apparatus 20 ends the current process.

In contrast, if the current security settings do not comply with the latest laws and regulations, a negative result is obtained in step 164. In this case, the image forming apparatus 20 notifies the user of this (step 165).

The notification to the user is performed by, for example, transmitting an e-mail or a message. A message indicating that the security settings need to be reviewed may be displayed on the control panel 24 (see FIG. 5).

If the current security settings do not comply with the latest laws and regulations, a mechanism for automatically setting the acquired recommended security without requesting a user's confirmation may be adopted.

### Second Processing Operation

While enforcement of new laws and regulations or amendment of existing laws and regulations is monitored in the first processing operation described above, enforcement of new laws and regulations does not necessarily mean that the recommended parameters need to be changed.

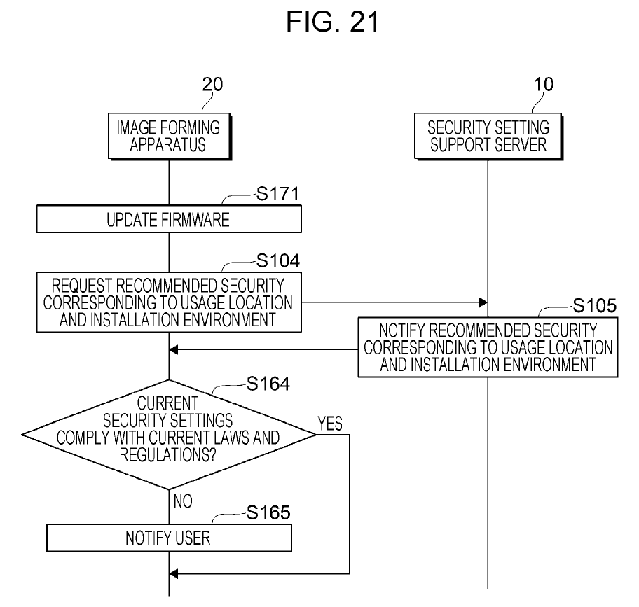

FIG. 21 is a diagram illustrating an exemplary processing sequence related to security setting of an image forming apparatus 20. In FIG. 21, parts corresponding to those in FIGS. 6 and 20 are denoted by corresponding reference numerals.

In the processing operation illustrated in FIG. 21, the security settings of the image forming apparatus 20 may be reviewed by using a firmware update as a trigger.

In FIG. 21, if the image forming apparatus 20 updates firmware (step 171), the image forming apparatus 20 requests recommended security corresponding to the usage location and the installation environment from the security setting support server 10 (step 104). The notification that firmware needs to be updated may be issued by the security setting support server 10 or another server. Firmware may be updated in response to an instruction from the administrator of the image forming apparatus 20.

In any case, the processing operation illustrated in FIG. 21 is triggered by update of firmware, and an inquiry about recommended security is transmitted to the security setting support server 10.

The security setting support server 10 updates recommended security corresponding to usage locations each time new laws and regulations and amended laws and regulations come into force. That is, the recommended security managed by the security setting support server 10 is updated to comply with the latest laws and regulations.

After that, the security setting support server 10 notifies the recommended security corresponding to the usage location and the installation environment (step 105).

In response to reception of the recommended security, the image forming apparatus 20 determines whether the current security settings comply with the latest laws and regulations (step 164).

If the current security settings comply with the latest laws and regulations, a positive result is obtained in step 164. In this case, the image forming apparatus 20 ends the current process.

In contrast, if the current security settings do not comply with the latest laws and regulations, a negative result is obtained in step 164. In this case, the image forming apparatus 20 notifies the user of this (step 165).

This configuration enables such operation that security settings comply with the latest laws and regulations even when new laws and regulations to be applied to a usage location are enforced or when existing laws and regulations are amended.

### Other Exemplary Embodiments

(1) The present exemplary embodiments of the present disclosure have been described. However, the technical scope of the present disclosure is not limited to the scope described in the above-described exemplary embodiments. It is apparent from the claims that various changes and improvements to the above-described exemplary embodiments are also included in the technical scope of the present disclosure.

(2) In the first exemplary embodiment, the recommended security to be presented to an image forming apparatus 20 is determined in accordance with a combination of the usage location and the installation environment. However, recommended security may be determined based only on usage location information.

(3) In the second and third exemplary embodiments, the image forming apparatuses 20 (see FIG. 1) have been described as entities that perform the processing operations. However, the security setting support server 10 (see FIG. 1) may be an entity that performs the processing operations. In this case, the security setting support server 10 may acquire relevant information from each image forming apparatus 20 which is to be managed, and may support security setting in accordance with the usage location.

(4) In the fifth exemplary embodiment, the security policy server 30 is provided separately from the security setting support server 10A. However, the security setting support server 10A and the security policy server 30 may be operated on a single server.

(5) In the exemplary embodiments described above, support of security setting of an image forming apparatus 20 (see FIG. 1) serving as an example of a network device is described. However, the target of security setting support may be any network device.

(6) In the exemplary embodiments, the processes are performed by any computer. The computer may perform the processes by using a processor serving as hardware, a program serving as software, or combination of these.

In this case, the processor is configured to perform the processes in the exemplary embodiments in cooperation with the program and may function as a unit or a means in the exemplary embodiments.

The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage).

The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

(7) The present disclosure is also applicable to a program and a program product.

### Appendix

### (((1)))

An information processing system comprising: a storage device that stores therein usage location information and a candidate of a security-related setting in association with each other, the usage location information including a country or a region, the candidate complying with a law and regulation corresponding to the usage location information; and a processor configured to: acquire the usage location information indicating a usage location where a target device is used; provide the acquired usage location information to the storage device and acquire the candidate of the setting, the candidate corresponding to the usage location information; and present the acquired candidate of the setting to a user of the target device.

### (((2)))

The information processing system according to (((1))), wherein the processor is configured to: acquire first usage location information by using an IP address of the target device, the IP address being an Internet Protocol address.

### (((3)))

The information processing system according to (((2))), wherein the processor is configured to: when second usage location information input by the user is different from the first usage location information acquired from the IP address, request the user to confirm the input second usage location information.

### (((4)))

The information processing system according to (((2))), wherein the processor is configured to: reacquire the IP address when a predetermined condition is satisfied; and when third usage location information corresponding to the reacquired IP address is different from the current usage location information which has been set, request the user to confirm the current usage location information.

### (((5)))

The information processing system according to any one of (((1))) to (((4))), wherein the processor is configured to: when the current setting does not comply with the law and regulation corresponding to the usage location information, request the user to change the setting.

### (((6)))

The information processing system according to (((5))), wherein the processor is configured to: when there is a change history in the law and regulation related to the usage location information, the change having been enforced after start of use of the current setting, determine that the current setting does not comply with the law and regulation corresponding to the usage location information.

### (((7)))

The information processing system according to (((5))), wherein the processor is configured to: when the current setting does not match the candidate of the setting corresponding to the usage location information, determine that the current setting does not comply with the law and regulation corresponding to the usage location information.

### (((8)))

The information processing system according to any one of (((1))) to (((7))), wherein the storage device stores therein a combination of the usage location information and installation environment information in association with the candidate of the security-related setting, and wherein the processor is configured to: acquire first installation environment information of the target device; and provide the acquired first installation environment information and the usage location information to the storage device, and acquire the candidate of the setting, the candidate corresponding to the combination of the first installation environment information and the usage location information.

### (((9)))

The information processing system according to (((8))), wherein the first installation environment information is classified based on a scale of the user who uses the target device.

### (((10)))

The information processing system according to (((8))), wherein the first installation environment information is provided in accordance with a security policy employed by the user who uses the target device.

### (((11)))

The information processing system according to any one of (((1))) to (((10))), wherein the processor is configured to: fail to accept a change of a setting, the change making security level lower than the candidate of the setting.

### (((12)))

The information processing system according to any one of (((1))) to (((11))), wherein the target device is a device configured to form an image on a sheet.

### (((13)))

A program for causing a computer to execute a process comprising: acquiring first usage location information including a country or region where a target device is used; providing the first usage location information to a storage device that stores usage location information and a candidate of a security-related setting in association with each other, the usage location information including a country or a region, the candidate complying with a law and regulation corresponding to the usage location information, and acquiring the candidate of the setting, the candidate corresponding to the first usage location information; and presenting the acquired candidate of the setting to a user of the target device.

What is claimed is:

1. An information processing system comprising:
a storage device that stores therein usage location information and a candidate of a security-related setting in association with each other, the usage location information including a country or a region, the candidate complying with a law and regulation corresponding to the usage location information; and
a processor configured to:
acquire the usage location information indicating a usage location where a target device is used;
provide the acquired usage location information to the storage device and acquire the candidate of the setting, the candidate corresponding to the usage location information; and
present the acquired candidate of the setting to a user of the target device.

2. The information processing system according to claim 1, wherein
the processor is configured to:
acquire first usage location information by using an IP address of the target device, the IP address being an Internet Protocol address.

3. The information processing system according to claim 2, wherein
the processor is configured to:
when second usage location information input by the user is different from the first usage location information acquired from the IP address, request the user to confirm the input second usage location information.

4. The information processing system according to claim 2, wherein
the processor is configured to:
reacquire the IP address when a predetermined condition is satisfied; and
when third usage location information corresponding to the reacquired IP address is different from the current usage location information which has been set, request the user to confirm the current usage location information.

5. The information processing system according to claim 1, wherein
the processor is configured to:
when the current setting does not comply with the law and regulation corresponding to the usage location information, request the user to change the setting.

6. The information processing system according to claim 5, wherein
the processor is configured to:
when there is a change history in the law and regulation related to the usage location information, the change having been enforced after start of use of the current setting, determine that the current setting does not comply with the law and regulation corresponding to the usage location information.

7. The information processing system according to claim 5, wherein
the processor is configured to:
when the current setting does not match the candidate of the setting corresponding to the usage location information, determine that the current setting does not comply with the law and regulation corresponding to the usage location information.

8. The information processing system according to claim 1, wherein
the storage device stores therein a combination of the usage location information and installation environment information in association with the candidate of the security-related setting, and
wherein the processor is configured to:
acquire first installation environment information of the target device; and
provide the acquired first installation environment information and the usage location information to the storage device, and acquire the candidate of the setting, the candidate corresponding to the combination of the first installation environment information and the usage location information.

9. The information processing system according to claim 8, wherein
the first installation environment information is classified based on a scale of the user who uses the target device.

10. The information processing system according to claim 8, wherein
the first installation environment information is provided in accordance with a security policy employed by the user who uses the target device.

11. The information processing system according to claim 1, wherein
the processor is configured to:
fail to accept a change of a setting, the change making security level lower than the candidate of the setting.

12. The information processing system according to claim 1, wherein
the target device is a device configured to form an image on a sheet.

13. A non-transitory computer-readable storage medium storing a program for causing a computer to execute a process comprising:
acquiring first usage location information including a country or region where a target device is used;
providing the first usage location information to a storage device that stores usage location information and a candidate of a security-related setting in association with each other, the usage location information including a country or a region, the candidate complying with a law and regulation corresponding to the usage location information, and acquiring the candidate of the setting, the candidate corresponding to the first usage location information; and
presenting the acquired candidate of the setting to a user of the target device.
